(19) United States
(12) Patent Application Publication
(10) Pub. No.: US 2006/0277069 A1
(43) Pub. Date: Dec. 7, 2006

(54) Preventing the accumulation of getter materials within the lung

(76) Inventor: Harold Edward Siess, Ooltewah, TN (US)

Correspondence Address: Harold E. Siess, 5595 Bryar Rose Dr., Ooltewah, TN, 37363, US

(21) Appl. No.: 11/503,082

(22) Filed: Aug. 14, 2006

Related U.S. Application Data
(63) Continuation-in-part of application No. 09/455,164, filed on Dec. 6, 1999, now Pat. No. 6,379,427.

(51) Int. Cl. G06Q 10/00

(52) U.S. Cl. 705/2

(57) ABSTRACT

The present invention provides for a method for preventing the accumulation in the body of oily or waxy type materials that act as a getter for toxic substances.

### INFORMATION DISCLOSURE STATEMENT

The following disclosure statement is made pursuant to the duty of disclosure imposed by law and formulated in 37 CFR 1.56(a). No representation is hereby made that information thus disclosed in fact constitutes prior art, inasmuch as 37 CFR 1.56(a) relies on a materiality concept which depends on uncertain and inevitably subjective elements of substantial likelihood and reasonableness and inasmuch as a growing attitude appears to require citation of material which might lead to a discovery of pertinent material though not necessarily being of itself pertinent. Also, the following comments contain conclusions and observations which have only been drawn or become apparent after conception of the subject invention or which contrast the subject invention or its merits against the background of developments which may be subsequent in time or priority.

### FIELD OF THE INVENTION

The present invention relates generally to the removal of non-toxic oily type materials from either water and/or air for preventing the accumulation of these types of materials within the organs of the body.

### BACKGROUND OF THE INVENTION

In the influenza pandemic of the early twentieth century, it was noted that passengers of the London “tubes” (the underground metro) had less of a chance of contracting the disease as compared to those who stayed at home. The reason for this irregularity has never been found. Early efforts to explain this phenomena centered on the presence of ozone in the air of the underground railroad. At the time, ozone was injected into the ventilation system in order to reduce the strong odors normally present. However, it was concluded that the residual concentration of ozone left was not of a sufficient magnitude to account for the decrease in the prevalence of influenza among the passengers. The author of this work believed that this phenomena was due to the formation of an invisible cloud of organic acids produced by the reaction of ozone with the odor molecules. Acid vapors, even at that time, had been known to reduce the probability of contracting various respiratory illnesses including influenza. Indeed, organic acid vapors were used at that time as a prophylactic treatment for influenza.

Though I believed that it was the organic acids formed in the above reaction that accounted for the decrease incidence of influenza, I could not know for certain that it was. For I did not even know what kind of odor molecules were present, much less what kinds of organic acids, if any, they produced in a reaction with ozone. Nevertheless, I thought it prudent to follow my instincts and devise a method and apparatus to accomplish the same effect that I believed was occurring in the underground railroad system during the influenza outbreak of 1918. An apparatus for the purification of air and detection of microbes and having the benefit of producing an optional residual concentration of organic acids in the air was developed by myself.

It should be pointed out, that there seems to be a general agreement in the field that organic acid vapors work, to some extent, by increasing the immune response. As such, it is not surprising that children with asthma are susceptible to these vapors and should not, as a rule, be exposed to them. Ways and means for increasing the anti-viral nature of the mist, and at the same time reducing the above mentioned effect has been conceptualized and will need to be tested. Until that work is completed, in those cases wherein the apparatus is used in a public place, the provision of a mask with an impregnated base incorporated therein may be appropriately provided for those children suffering from such a condition.

After filing the above mentioned patent application, I put forth an effort in developing a method and apparatus for diagnosing individuals with influenza and other respiratory diseases at such places as airports in hopes of stopping the spread of the disease once it broke out somewhere on the globe. Up to that point, things had turned out so badly that I contacted the youth pastor I had as a child for advice. He arranged for a place and a means for competing the work for diagnosing influenza at a medical university in California. In addition, theories that I had developed as to why patients inside hospitals seemed to have a decreased immune response would be explored. However, my wife would not move out there with me and insisted on moving herself and our two boys to Chattanooga Tennessee where her parents were to help her. After moving her and the children to Chattanooga, the professor I intended to work with had a sudden and acute heart attack.

After buying our new home, I met a woman and we started talking. She told me of the general lack of health among the children there with such a sorrowful tone in her voice that it pierced me. I did not want to do that type of work anymore. I had given up hope. But the pain I felt that day did not go away. I therefore decided to go ahead and try and find out why the children around our neighborhood and around a nearby nuclear power plant were in such ill health. This application is the culmination of that work and is given in memory of my mother, Kathryn Ann Carraway.

It is common in everyday life to be exposed to vapors containing oil or wax type materials. Exposure to non-volatile oily vapors often occurs incidently during the cooking of food or in the process of coating surfaces with oil or wax droplets from spray cans. Many of us purposely expose ourselves to these vapors when we spray an air freshener into the air, burn scented candles, use plug in air-fresheners or take an aroma-therapy treatment.

The above mentioned oil and wax type substances are non-toxic. Indeed, some types of oils, such as silicon oils are so inert that they are currently injected or otherwise placed into our bodies in order to obtain a more pleasing appearance. The inert character of silicone oils has lead to their use in a number of medical and consumer products. The silicone oils used in these products eventually find their way into steams, rivers and municipal water supplies.

Though it is quite true that these compounds are non-toxic and appear not be metabolically altered so as to become toxic, they are nevertheless quite harmful in that the accumulation or continuous exposure to these types of materials most certainly leads to an increase risk of severe illness and/or death. For the accumulation or continuous exposure of these materials; (1) increases the concentration of toxins pulled into our bodies from the environment and (2) alters where toxic compounds are stored and metabolized within the body such that their toxic nature becomes manifest in otherwise immune locations.

Below is given an outline of how the accumulation of or constant exposure to oily or waxy type materials alter the uptake and metabolism of one group of toxic compounds, namely the polycyclic aromatic hydrocarbons within the lung. In this hastily compiled outline, the occurrence of oily or waxy type materials within the lung is shown both to increase the uptake of polycyclic aromatic hydrocarbons from the atmosphere and to alter the metabolism of these compounds such that toxic substances are produced within the lung and disseminated throughout the body rather than being detoxified in the liver as would normally occur. After the outline, a series of epidemiological studies dealing with the increase incidence of lung cancer due to the accumulation of oily or waxy type materials within the lung is given to provide an actionable conclusion as to whether or not to regulate these substances in municipal water supplies and in the water used in cooling towers.

I. The Currently Accepted Model for the Clearance of Aerosol Particles from the Lung

Upon inhalation of air, hydrophobic aerosol particles in the form of minute oil and wax droplets can be drawn into the upper respiratory tract. The particles that are not removed from the air in the upper respiratory tract pass into the lung.

Solid and liquid particles made of oily hydrophobic matter can be deposited in the ciliated portion of the conducting airways. In the current model, these oily particles are cleared from the respiratory tract by being propelled by the mucociliary clearance mechanism into the pharynx and ultimately swallowed or expectorated (spat). In the operation of the mucociliary clearance mechanism the mucus layer is propelled upward by the ciliated action of the respiratory epithelial cells. During this flow process, the cilia grab onto the lower portion of the entangled network of proteins that make up the mucosal layer with claws that are attached at their ends and move the layer upward. The cilia do not extend through the mucosal layer and therefore cannot directly propel particles or fluids lying on top of the mucosal lining. Apparently, it is currently believed that deposited oily particles become attached to the outer surface of the mucosal layer and ride up with it at the same rate of speed. The slow rate of clearance of oily type materials, which is found experimentally, is given as a result of the decreased function of the cilia in the presence of oily materials and not to any differences in the rate of speed of the oily material and the mucosal layer.

In the current model, oily particles which reach the alveolar regions of the lungs are removed by scavenging macrophages or if small enough may pass into the blood. The macrophages either carry the engulfed aerosol particles up the airways toward the mucociliary escalator or migrate to the lymphatic vessels where the particles might remain in an inert state or be transported into the blood.

II. Problems Associated with the Currently held Model for the Clearance of Hydrophobic Aerosol Particles from the Lung

The Formation of Non-Attached Oil Slicks by the Spreading of Oil Droplets

As noted above, in the currently held model for the clearance of oil droplets from the lung, the oil droplets are treated as solid particles in that there is no accounting for the spreading of the oil on the surface of the lining of the respiratory tract. The oil droplets will, of course, spread out on the surface of the respiratory tract by the force of gravity and the drag forces produced by the movement of the air over the surface. The oil droplets spread out to form an oil slick on the mucus layer covering the ciliated portion of the respiratory tract.

During the upward flow of mucus the oil slick can become detached from the mucosal layer and move down the respiratory tract in an opposite direction of the mucosal flow. The detachment of oil slicks from underling aqueous flows are seen in the ocean after an oil spill wherein the oil slick moves in the direction of the wind rather than the ocean currents.

The fact that oily type materials do indeed flow down the respiratory tract can clearly be seen in the processes occurring during the onset of exogenous lipoid pneumonia [Spickard and Hirschmann 1994 also Becton et al., 1984] In exogenous lipoid pneumonia, an oily material, such as mineral oil, or animal or vegetable oils are aspirated, inhaled or otherwise pass into the respiratory tract. Due to the hydrophobic nature of the oily material it does not mix with the mucosal layer but rather glides down over the outer surface of the mucociliary escalator of the respiratory tract and into the alveolar compartments of the lung where it can accumulate. In some people, the accumulation of oily material within the alveolar compartments causes no signs and symptoms. In others, signs and symptoms develop gradually and may include cough and shortness of breath.

The shortness of breath associated with the accumulation of oils within the alveolar compartments is due to the reduced ability of the lungs to adequately pass oxygen onto the blood. Under these conditions, the oily material acts as a barrier to the passage of oxygen. The effectiveness of this barrier is related to the solubility of oxygen within the oily material itself. The lower the solubility of oxygen the greater the barrier to the passage of oxygen onto the blood. For oily materials, such as silicone oils, that have high oxygen solubilities, there may be no symptoms of shortness of breath.

The development of a cough associated with exposure of oily aerosols is, at least in part, due to the ability of these types of materials to elicit a response from neuro-transmitting cells located beneath the aqueous mucosal layer. The ability of the oily material to stimulate coughs is directly related to the probability of the material diffusing through the aqueous mucosal layer and coming into direct contact with these types of cells. In general, therefore, the lower the aqueous solubility of the oily material the lower the level of cough response. For extremely hydrophobic materials, such as silicone oils, there may be no cough response elicited.

From the above analysis, it should be of no surprise to find that the accumulation of silicone oils within the lung due to the migration of silicone type materials used in breast implants has been shown to be asymptomatic in regards to oxygen transport. The migration of ingested silicone oils into the blood stream has been shown to occur for some types of silicone oils. The movement of these oils out of the blood stream and into the lung is, I believe, likely to occur. The accumulation of these oils within the lung are also expected to be asymptomatic in nature.

III. Current Model of the Clearance of Volatile Hydrocarbons from the Lung

In the currently held model for the absorption and clearance of volatile hydrocarbons, the inhaled gaseous hydrocarbons are absorbed into an aqueous surface layer that covers the lining of the respiratory tract. Hydrocarbons that are absorbed in the conducting region of the lung are cleared by one of the following mechanisms: (1) pass by diffusional processes directly into the blood, (2) pass out of the respiratory tract by way of the mucociliary escalator, (3) enter the lymphatic system through one of the many lymph nodes, or (4) be actively or passively absorbed into one or more cell types that line the respiratory tract where they may be metabolized or pass onto either the lymphatic or blood systems.

IV. Problems with the Current Model for the Absorption and Clearance of Volatile Hydrocarbons from the Lung

The currently held model for the absorption and clearance of volatile hydrocarbons does not account for the presence of oily or waxy formations within the lung. In those cases wherein there is a constant exposure of oily or waxy type vapors, the resultant oil slick that covers the respiratory tract would be expected to greatly increase the uptake of these types of materials from the air. In addition, the downward movement of the oil slick would retain these types of materials within the lung where they would be either metabolized or passed onto the blood. It should be noted, that the oil slick formed in the respiratory tract would also increase the uptake of aerosol particles from the air. For it is common to spread an oil layer on the surfaces of impact separators for decreasing the bounce probability and thereby increasing the uptake of aerosol particles.

V. Currently Held View on What is Toxicolically Harmful

It is currently held that in order for particles in ambient air to be harmful they must be both toxic and present in a sufficient amount. If the particles are not toxic, they may simply accumulate in the lung but cause no harm.

VI. The Toxicology of Polycyclic Aromatic Hydrocarbons

It is generally known in the field of toxicology, that the level of toxicity of some compounds, such as polycyclic aromatic hydrocarbons (PAHs), is dependent upon where they are metabolized in the body. For example, the metabolism of PAHs in the lung leads to an increase in the production of toxic substances as compared to their metabolism in the liver. The toxic substances produced by the metabolism of PAHs in the lung are mutenagenic, carcinogenic, lower the immune response and lead to an increased risk of auto-immune disorders such as type II diabetes among others.

VII. Problems with the Current View on what is Toxicolically Harmful

A molecular species need not be toxic in itself or be metabolized into a toxic agent for it to be harmful. A molecular species can be harmful if it changes the rate at which other chemical species are metabolized and/or where they are metabolized such that toxic agents are produced. For example, the above mentioned oil slick that forms upon the inhalation of oily or waxy type materials do not represent a toxic event. However, it does increase the rate of uptake of particles and toxic non-polar molecular species such as, for example, polycyclic aromatic hydrocarbons from the air.

If a normal person were to accidently spill gasoline in his or her garage, the polycyclic aromatic hydrocarbons contained with the gasoline vapors would be inhaled and pass into the aqueous fluid lining of the lungs in an amount in accordance with their aqueous solubility. The solubilized polycyclic aromatic hydrocarbons would then either move up the mucociliary escalator or pass into the blood stream. The polycyclic aromatic hydrocarbons would be metabolized into toxic agents by tissues of the lung, brain, and other organs containing CPY 1 enzymes. However, due to the high concentration of non-CPY 1 metabolic enzymes in the liver, most of the polycyclic aromatic hydrocarbons would be metabolized there into non-toxic agents.

In a person exposed to hydrophobic agents in a manner such that an oily layer forms on the fluid lining of the lungs were to accidently spill gasoline in his or her garage, the polycyclic aromatic hydrocarbons would be inhaled and pass into the oil slick in accordance with their solubility in non-polar solvents. The solubility of the polycyclic aromatic hydrocarbons in non-polar solvents is several of orders of magnitude greater than in water. They would not be brought up the mucociliary escalator, but rather ride down the respiratory tract with the oil slick.

After being retained within the oil slick, they would only slowly pass on to the blood where they could be metabolized by the liver. As such, the majority of the inhaled polycyclic aromatic hydrocarbons would be metabolized in the lung thereby producing a large concentration of toxic agents. The toxic agents would poison the lung or be passed into the blood stream and onto other vital organs.

Not only would the inhaled hydrocarbons be retained in the lung but the lung itself would pull ingested toxic hydrocarbons from the blood and metabolize them there.

A lung that has been exposed in such a manner as to make it act like a sponge for hydrophobic toxic agents is wherein called a lipophilic lung. Lipophilic lung disorder can be more accurately defined as a disorder of the lung wherein the uptake and/or metabolism of hydrocarbons have been altered by the presence of extraneous organic agents in the fluid lining of the lungs.

Epidemiological Studies on the Increase Risk of Cancer Associated with Lipophilic Lung Disorder

There has been several studies done on factors that increase the risk of lung cancer. With the exception of the increased risk of lung cancer associated with exposure to radiation, all the studies that I have found on the increased risk of lung cancer can be explained by the occurrence of lipophilic lung disorder.

1. Aerosol particles that are emitted from aeration tanks of wastewater treatment plants are enriched with hydrophobic materials, such as natural and synthetic oils, and skatol. In one study done in Plato Italy, the inhalation of such aerosol particles around sewage treatment plants has been associated with an increased risk of respiratory cancer.

2. It is well known that the inhalation of oil fumes from woks increases the risk of lung cancer. In addition, and not surprising, the incidence of lung cancer is 4 times the average for those women who are exposed to such vapors and smoke.

3. The evaporation of river water in the cooling towers of power plants would be expected to produce large amounts of aerosol particles in the form of natural and synthetic oils. There have been many reports of increased illness and cancers associated with these plants.

4. Desert birds produce a fine oily dust that is disseminated through the homes of those who keep them as pets. This dust is inhaled by the occupants of these homes resulting in a lipophilic lung. A significant increase in the rate of lung cancer of these occupants has been noted. It is interesting to note that the birds themselves inhale these powders for the purpose of coating their lungs with a wax like material for reducing water loss in the desert environment. (Authors thoughts)

5. In the normal use of a sauna, it is common for oils to be evaporated into the enclosed atmosphere. There has been noted an increased risk of lung cancer with those who take a sauna regularly. (Finish study)

6. Butchers use mineral oils in both their cutting machines and for covering their wooden butchers blocks. The use of these machines and the pounding of the covered blocks produce oily aerosol particles that are inhaled. It has been shown that there is a significant increase in the risk of various cancers including lung cancer for this group of workers. (New Zealand study)

In regards to developing lung cancer, it should be noted that the exposure to machine oils used in the cutting of metals does not lead to an increase in the risk of cancer.

In addition to the inhalation of oily type materials, there are also two other ways to develop a lipophilic lung. The two other methods by which one can develop a lipophilic lung are (1) the passage of lipids or oily type materials from the blood into alveolar regions of the lung and (2) the colonization of the lung by lipid or wax-covered bacteria. In all these cases there has been shown to be an increase in the risk of cancer.

1. The passage of silicone oils into the lungs of breast implant recipients have been shown to increase the risk of lung cancer. It is interesting to note that there is also an increase risk of brain cancer and that silicone oils have been shown to form deposits there as well. In addition, the auto-immune response disorders that have been associated with the accumulation of silicone oils is consistent with exposure to high levels of polycyclic aromatic hydrocarbons.

2. The passage of cholesterol from the blood into the alveolar region has been shown to increase the risk of lung cancer.

3. The presence of tuberculosis within the lung has been shown to increase the risk of lung cancer in several studies as well as other types of bacterial infections. I was never able to find out what other types of bacteria were associated with an increase in lung cancer.
Spickard III A, Hirschmann J. Exogenous Lipoid pneumonia. Arch. Intern. Med., 1994, vol. 154 pgs. 686-692
Becton D. L., Lowe J. E., Falletta J. M., Lipoid pneumonia in an adolescent girl secondary to use of lip gloss. J. Pediatr. 1984, vol. 105 pgs. 421-423.

Due to the lack of a non-evasive method for the detection of silicone oils within the body at this time and due to a rather bleak prospect for removing these materials from the lung and brain at this time, I will make the following known. In a series of patent applications to be filed later, an outline of how waxy cholesterol deposits (plaque) within arterial walls acts as a sponge for hydrophobic toxic compounds, such as polycyclic aromatic hydrocarbons, will be presented. The accumulation of these toxic compounds within these deposits is given as the reason for the inflamation, degradation and subsequent failure of the arterial wall surrounding these plaque deposits. Methods for the detection and removal of cholesterol and extraneous oily or waxy type materials, including silicone oils, from the body will then be given in those upcoming applications.

### SUMMARY OF THE INVENTION

The present invention provides for a method for preventing the accumulation in the body of oily or waxy type materials that act as a getter for toxic substances. In the method of operation, oily or waxy type materials are removed from contaminated water supplies. After their removal, oily or waxy type materials in the form of silicone oils are disposed of by incineration. Means is provided for detecting unburnt silicone oils.

### BRIEF DESCRIPTION OF THE DRAWINGS

FIG. 1, shows a shows schematic of a method for preventing the accumulation of oily or waxy type materials within the body.

### DETAILED DESCRIPTION OF THE INVENTION

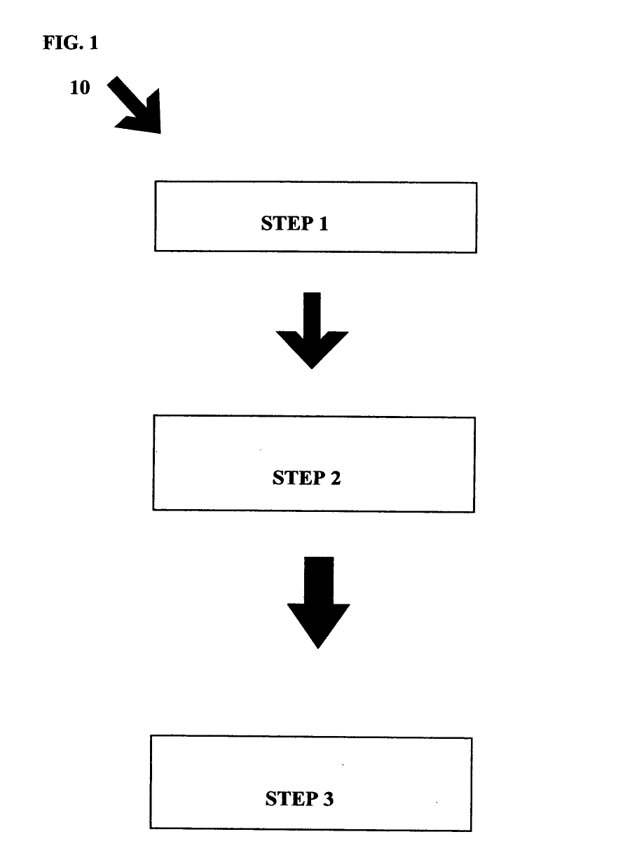

Now referring to FIG. 1, there is shown a schematic of a process, generally indicated by the numeral 10, for the removal of oils from water supplies for preventing the accumulation thereof in human tissues.

Process 10 is useful in preventing the accumulation of oils, which may be non-toxic in nature, such as for example, mineral and silicone oils found in contaminated water supplies, in tissues of the organs of the lung and/or brain. More particularly, process 10 is useful for preventing oils, which may be commonly found in contaminated municipal water supplies and water supplies used in cooling towers from accumulating in the lung and/or brain for preventing these organs from acting as a sponge for toxic hydrophobic agents.

In step 1 of process 10, regulations are made by governmental bodies for regulating the discharge of oily or waxy type materials into the air from cooling towers and/or sewage treatment plants.

In step 2 of process 10, oily or waxy type materials, which may be in the form of silicone compounds, are removed from the water supplies by methods and means known in the art of water purification for preventing there accumulation in human tissues.

In step 3 of process 10, the removed oily or waxy type materials are disposed of by incineration. The incinerator may be equipped with detector for detecting the presence of unburnt silicone oils. The detector can be, but is not limited to, a gas chromatograph/mass spectrometer.

I claim:

1. A method for preventing the accumulation of oils within human tissues, said method comprising the step removing at least a portion of said oils from water supplies.

2. A method as in claim 1, wherein the said oil is in the form of a silicone oil.

3. A method as in claim 1, further comprising the step of testing said water supplies for the presence of said oils.

4. A method as in claim 1, wherein the said water supply is a municipal water supply.

5. A method as in claim 1, wherein the said water supply is a water supply used in a cooling tower.

6. A method as in claim 1, further comprising the step of testing a least a portion of the emission from a cooling tower for the presence of aerial oils.
